(19) United States
(12) Patent Application Publication
(10) Pub. No.: US 2024/0028348 A1
(43) Pub. Date: Jan. 25, 2024

(54) EXTENSION OF NETWORK PROXY TO TRAFFIC FOR TETHERED OR OTHER COMPANION DEVICE

(71) Applicant: Samsung Electronics Co., Ltd., Suwon-si (KR)

(72) Inventors: Vignesh Saravanaperumal, San Jose, CA (US); Sanjay Annaso Patil, Milpitas, CA (US)

(21) Appl. No.: 18/181,703

(22) Filed: Mar. 10, 2023

Related U.S. Application Data
(60) Provisional application No. 63/390,581, filed on Jul. 19, 2022.

(51) Int. Cl. G06F 9/445; H04L 9/40; H04L 67/56

(52) U.S. Cl. CPC G06F 9/44505; H04L 63/0281; H04L 67/56

(57) ABSTRACT

A method includes obtaining, at a first electronic device, first and second proxy auto-configuration (PAC) files. The method also includes executing, by the first electronic device, a first local proxy server configured to receive traffic forwarded by the first electronic device and at least one second electronic device. The first local proxy server is configured to forward the traffic based on the first PAC file. The method further includes executing, by the first electronic device, a second local proxy server configured to forward the traffic from the second electronic device(s) to the first local proxy server based on a second PAC file. The method also includes receiving, at the first local proxy server from the second local proxy server, the traffic from the second electronic device(s). In addition, the method includes forwarding, using the first local proxy server, the traffic from the second electronic device(s) to an external proxy server.

### CROSS-REFERENCE TO RELATED APPLICATION AND PRIORITY CLAIM

This application claims priority under 35 U.S.C. § 119(e) to U.S. Provisional Patent Application No. 63/390,581 filed on Jul. 19, 2022. This provisional application is hereby incorporated by reference in its entirety.

### TECHNICAL FIELD

This disclosure relates generally to communication and network systems. More specifically, this disclosure relates to an extension of a network proxy to traffic for a tethered or other companion device.

### BACKGROUND

It is common for a user to have multiple personal electronic devices, such as a smartphone, a smartwatch or other wearable, a laptop computer, and a tablet computer. Often times, one or more of the user's electronic devices are unable to communicate over a cellular network or other communication network. For example, while a user's smartphone can communicate over a cellular network by design, the user's smartwatch or other wearable, laptop computer, tablet computer, or other electronic device may lack this ability. In these or other instances, the user may often “tether” his or her smartwatch or other wearable, laptop computer, tablet computer, or other electronic device to the user's smartphone, thereby allowing the user's other device(s) to communicate over the cellular network via the user's smartphone.

### SUMMARY

This disclosure relates to an extension of a network proxy to traffic for a tethered or other companion device.

In a first embodiment, a method includes obtaining, at a first electronic device, a first proxy auto-configuration (PAC) file. The method also includes executing, by the first electronic device, a first local proxy server configured to receive traffic from the first electronic device and at least one second electronic device. The first local proxy server is configured to forward the traffic based on the first PAC file. The method further includes executing, by the first electronic device, a second local proxy server configured to forward the traffic from the at least one second electronic device to the first local proxy server. The method also includes receiving, at the first local proxy server from the second local proxy server, the traffic from the at least one second electronic device. In addition, the method includes forwarding, using the first local proxy server, the traffic from the at least one second electronic device to an external proxy server.

In a second embodiment, an electronic device includes at least one communication interface configured to communicate with at least one second electronic device. The electronic device also includes at least one processing device configured to obtain a first PAC file. The at least one processing device is also configured to execute a first local proxy server configured to receive traffic from the electronic device and the at least one second electronic device. The first local proxy server is configured to forward the traffic based on the first PAC file. The at least one processing device is further configured to execute a second local proxy server configured to forward the traffic from the at least one second electronic device to the first local proxy server. The at least one processing device is also configured to receive, at the first local proxy server from the second local proxy server, the traffic from the at least one second electronic device. In addition, the at least one processing device is configured to forward, using the first local proxy server, the traffic from the at least one second electronic device to an external proxy server.

In a third embodiment, a non-transitory machine readable medium contains instructions that when executed cause at least one processor of an electronic device to obtain a first PAC file. The non-transitory machine readable medium also contains instructions that when executed cause the at least one processor to execute a first local proxy server configured to receive traffic from the electronic device and at least one second electronic device. The first local proxy server is configured to forward the traffic based on the first PAC file. The non-transitory machine readable medium further contains instructions that when executed cause the at least one processor to execute a second local proxy server configured to forward the traffic from the at least one second electronic device to the first local proxy server. The non-transitory machine readable medium also contains instructions that when executed cause the at least one processor to receive, at the first local proxy server from the second local proxy server, the traffic from the at least one second electronic device. In addition, the non-transitory machine readable medium contains instructions that when executed cause the at least one processor to forward, using the first local proxy server, the traffic from the at least one second electronic device to an external proxy server.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts;

FIG. 1 illustrates an example network configuration including an electronic device in accordance with this disclosure;

FIG. 2 illustrates an example process for extending a network proxy to traffic for a tethered or other companion device in accordance with this disclosure;

FIG. 3 illustrates an example signaling diagram for extension of a network proxy to traffic for a tethered or other companion device in accordance with this disclosure; and

FIG. 4 illustrates an example method for extending a network proxy to traffic for a tethered or other companion device in accordance with this disclosure.

### DETAILED DESCRIPTION

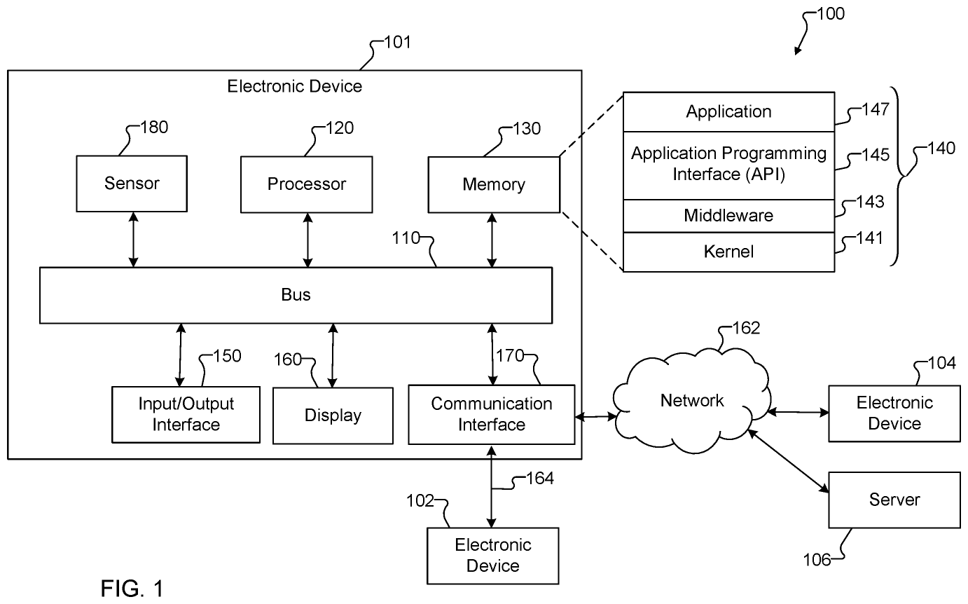

FIGS. 1 through 4, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, it is common for a user to have multiple personal electronic devices, such as a smartphone, a smartwatch or other wearable, a laptop computer, and a tablet computer. Often times, one or more of the user's electronic devices are unable to communicate over a cellular network or other communication network. For example, while a user's smartphone can communicate over a cellular network by design, the user's smartwatch or other wearable, laptop computer, tablet computer, or other electronic device may lack this ability. In these or other instances, the user may often “tether” his or her smartwatch or other wearable, laptop computer, tablet computer, or other electronic device to the user's smartphone, thereby allowing the user's other device(s) to communicate over the cellular network via the user's smartphone.

The ability to tether electronic devices may be very convenient for end users, but it can raise a number of problems in enterprise settings or other settings where security issues are of concern. For example, an employee may routinely use his or her smartphone to access electronic resources of his or her employer. In some cases, the user's smartphone may actually be owned by the user's employer and issued to the user. In order to guard against malware, illicit access, and other cyberthreats, the employer often restricts or controls the abilities of the user's smartphone, such as when accessing the employer's electronic resources. It is also becoming more common for users to have enterprise-issued laptops, smartwatches or other wearables, or other electronic devices. While the user may wish to tether his or her other electronic devices to the user's smartphone, this makes it very challenging for the enterprise to support network configurations, manage and monitor/audit traffic for each electronic device, and generally ensure that all of the user's electronic devices are behaving appropriately and honoring all security policies or other policies. In some cases, for instance, an administrative user or other personnel may need to configure proxy settings or other settings of each electronic device used by each user of the enterprise.

This disclosure provides techniques for extending a network proxy of one device (such as a tethering device) to traffic for at least one other device (such as at least one tethered or other companion device). As described in more detail below, the tethering device can obtain a first proxy auto-configuration (PAC) file. The tethering device can also execute first and second local proxy servers. The first local proxy server can be configured to receive traffic from the tethering device and the tethered device, and the first local proxy server can be configured to forward the traffic based on the first PAC file. The second local proxy server can be configured to forward the traffic from the tethered device to the first local proxy server, where the tethered device provides the traffic to the second local proxy server based on a second PAC file. The first local proxy server can receive the traffic from the tethered device via the second local proxy server, and the first local proxy server can forward the traffic from the tethered device to an external proxy server.

In this way, it is possible to utilize or extend a network proxy configuration for one device (such as a smartphone) to one or more other devices (such as a smartwatch or other wearable, a laptop computer, a tablet computer, or an Internet of Things or “IoT” device). The network proxy configuration can be extended more easily to other devices since there is no need for an administrator or other personnel to separately push network proxy configurations to all of the tethering and tethered devices individually. Instead, the network proxy configurations may only need to be provided to the tethering devices. Moreover, this approach allows for simplified monitoring and auditing of network traffic for the tethering and tethered devices since all traffic for each user may have a single end-point of entry (the tethering device) or some other reduced number of entry points. Further, this approach can help to reduce deployment and monitoring costs. In addition, various functions or features may be incorporated to provide even better security, such as when a virtual private network (VPN)-based proxy of the tethering device can be extended and used to transport traffic of the tethered device.

Note that while it may often be assumed that a user's smartphone is used as a tethering device and that one or more of the user's other electronic devices are used as one or more tethered devices, this need not be the case. Any suitable electronic device may be used as a tethering device, and any suitable electronic device may be used as a tethered device. Examples of both tethering devices and tethered devices may include smartphones, smartwatches or other wearables, laptop computers, tablet computers, IoT devices, televisions, or other portable or fixed electronic devices as defined above. Also note that a tethering device may be used with any suitable number of tethered devices and that the number of tethered devices used with the tethering device may vary over time.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described below, the processor 120 may be used to perform various functions related to extending a network proxy, such as a hypertext transfer protocol (HTTP) proxy or HTTP Secure (HTTPS) proxy, used by the electronic device 101 to traffic for at least one tethered or other companion device.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications for extending a network proxy used by the electronic device 101 to traffic for at least one tethered or other companion device. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals, such as images.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, one or more of the external electronic devices 102, 104 may tether to or otherwise communicate with the electronic device 101. As described below, the electronic device 101 can be used to extend a network proxy used by the electronic device 101 to traffic for the external electronic device(s) 102, 104. Among other things, this may allow the external electronic device(s) 102, 104 to communicate with one or more external components (such as an external proxy server) using the network proxy of the electronic device 101.

In some implementations, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more cameras.

The wireless communication is able to use at least one of, for example, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include, for example, at least one of a universal serial bus (USB), high definition multimedia interface (HDMI), recommended standard 232 (RS-232), or plain old telephone service (POTS). The network 162 includes at least one communication network, such as a computer network (like a local area network (LAN) or wide area network (WAN)), Internet, or a telephone network.

The first and second external electronic devices 102 and 104 and server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

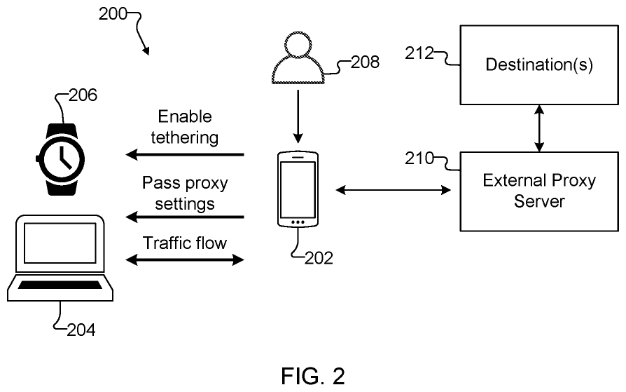

FIG. 2 illustrates an example process 200 for extending a network proxy to traffic for a tethered or other companion device in accordance with this disclosure. For example, the process 200 of FIG. 2 may be implemented within the network configuration 100 of FIG. 1, such as when the electronic device 101 is used as a tethering device and one or more of the electronic devices 102, 104 are used as at least one tethered device. However, the process 200 shown in FIG. 2 could be used with any other suitable devices and in any other suitable systems.

As shown in FIG. 2, the process 200 generally allows a network proxy used by a tethering device 202 to be extended for use with traffic associated with one or more tethered devices 204, 206. In some cases, the tethering device 202 may represent the electronic device 101 in FIG. 1, and the tethered devices 204, 206 may represent the electronic devices 102, 104 in FIG. 1. In this particular example, the tethering device 202 represents a smartphone, and the tethered devices 204, 206 represent a smartwatch and a laptop computer. However, as noted above, each of the tethering and tethered devices 202, 204, 206 may represent any suitable electronic device.

At least one user 208 interacts with the tethering device 202 in order to configure one or more network proxies of the tethering device 202. For example, the user 208 may enable a tethering function of the tethering device 202, enable and configure proxy settings (such as HTTP or HTTPS proxy settings) on the tethering device 202, and enable local proxy servers on the tethering device 202. The local proxy servers are described below and allow the one or more tethered devices 204, 206 to communicate via the tethering device 202 while supporting the proxy settings of the tethering device 202. The at least one user 208 here may represent at least one administrative user or other personnel who are authorized to control network proxies of electronic devices (including the tethering device 202). As a particular example, the at least one user 208 may represent one or more information technology (IT) administrators of an enterprise.

When a user wishes for a tethered device 204, 206 to communicate via the tethering device 202, the tethering device 202 can interact with the tethered device 204, 206 in order to support the extension of the tethering device's network proxy to traffic associated with the tethered device 204, 206. For example, as shown in FIG. 2, some of these interactions can include the tethering device 202 enabling a tethering function of the tethered device 204, 206 and passing proxy settings to the tethered device 204, 206. Data traffic can then flow to and from the tethered device 204, 206, and the tethering device 202 can operate to ensure that the data traffic is transmitted to and received from the tethered device 204, 206 in accordance with the proxy settings of the tethering device 202. Effectively, this approach allows the data traffic associated with the tethered device 204, 206 to flow through the network proxy that is configured on the tethering device 202.

As can be seen in FIG. 2, the tethering device 202 is able to communicate data traffic (both its own data traffic and data traffic for the tethered device(s) 204, 206) to an external proxy server 210. The ability to transport data traffic between the tethering device 202 and the external proxy server 210 is controlled by the proxy configuration of the tethering device 202. The external proxy server 210 represents a proxy server that is external to the tethering and tethered devices 202, 204, 206 and that acts as a proxy for the tethering device 202. The external proxy server 210 is able to route data traffic to and receive data traffic from one or more destinations 212, which represent one or more hosts or other components interacting with at least one of the devices 202, 204, 206.

As shown in this example, the tethered device(s) 204, 206 can interact with the external proxy server 210 and the one or more destinations 212 via the tethering device 202. As described below, the tethering device 202 supports the use of multiple local proxy servers and other functions that enable the network proxy configuration of the tethering device 202 to be extended to the data traffic for the tethered device(s) 204, 206. This allows the tethered device(s) 204, 206 to interact with the external proxy server 210 and the one or more destinations 212 in compliance with the network proxy configuration of the tethering device 202. Moreover, as can be seen in FIG. 2, the user 208 may not need to provide any type of proxy configurations to the tethered device(s) 204, 206 (this may still occur if desired, but it is not necessarily required). Instead, the user 208 is able to configure the proxy on the tethering device 202, and the same proxy configuration can be extended to support the tethered device(s) 204, 206. As a result, all network traffic (such as HTTP or HTTPS traffic) associated with the tethered device(s) 204, 206 can traverse through the tethering device 202, and the tethering device 202 can effectively function as a local proxy server and forward the traffic to the external proxy server 210. This can help to greatly simplify the management of electronic devices, such as in various enterprises like companies, governmental entities, or other groups having large numbers of users and electronic devices.

In some instances, the tethering device 202 may support the use of one or more VPNs, in which case the tethering device 202 can support a VPN proxy. In these cases, for example, the tethering device 202 may establish a VPN-based connection with the external proxy server 210, and the VPN-based connection can be supported by the VPN proxy of the tethering device 202. In these embodiments, it is possible to extend the VPN proxy used by the tethering device 202 to the traffic associated with the tethered device(s) 204, 206 using the approach described above. For example, the tethering device 202 can route traffic associated with the tethered device(s) 204, 206 using the VPN proxy supported by the tethering device 202. This can improve security and allow the traffic associated with the tethered device(s) 204, 206 to be secured using the VPN proxy of the tethering device 202.

It should be noted that the functions shown in or described with respect to FIG. 2 can be implemented in electronic devices 101, 102, 104 or other electronic devices in any suitable manner. For example, in some embodiments, at least some of the functions shown in or described with respect to FIG. 2 can be implemented or supported using one or more software applications or other software instructions that are executed by the processors 120 of the electronic devices 101, 102, 104 or other electronic devices. In other embodiments, at least some of the functions shown in or described with respect to FIG. 2 can be implemented or supported using dedicated hardware components. In general, the functions shown in or described with respect to FIG. 2 can be performed using any suitable hardware or any suitable combination of hardware and software/firmware instructions.

Although FIG. 2 illustrates one example of a process 200 for extending a network proxy to traffic for a tethered or other companion device, various changes may be made to FIG. 2. For example, the tethering device 202 may be used with any suitable number of tethered devices. Also, the tethering device 202 may support any suitable number of network proxy configurations that enable communication with any suitable number of external proxy servers 210.

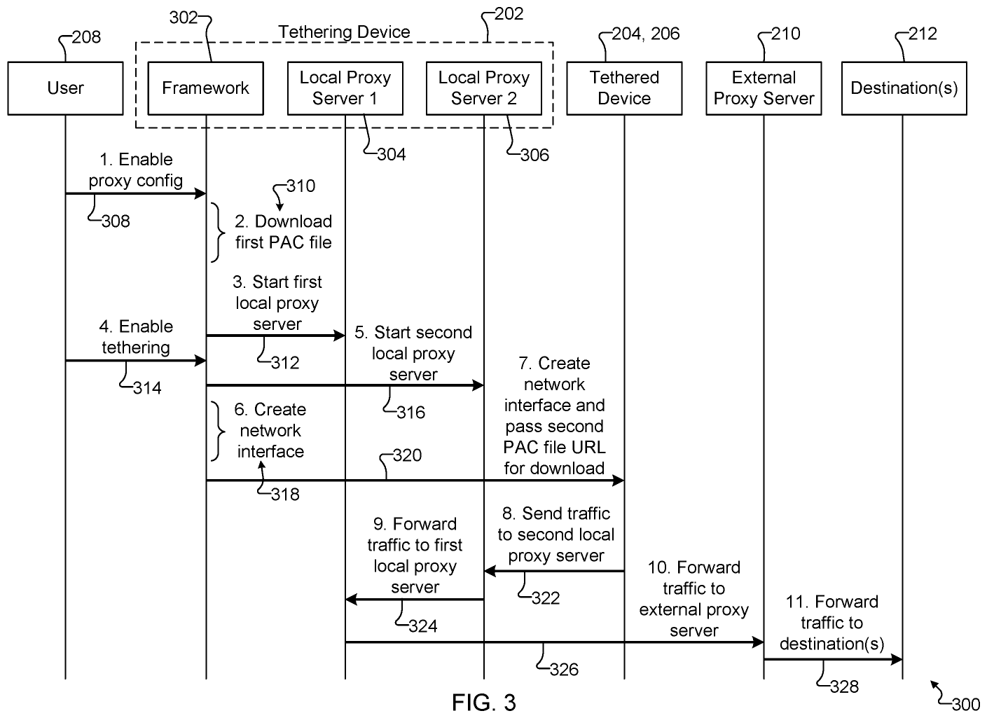

FIG. 3 illustrates an example signaling diagram 300 for extension of a network proxy to traffic for a tethered or other companion device in accordance with this disclosure. For ease of explanation, the signaling diagram 300 of FIG. 3 is described as involving the various elements 202-212 shown in FIG. 2 and described above, and these elements 202-212 may be associated with the network configuration 100 of FIG. 1. However, the same or similar types of signaling may be used with other suitable elements and in other suitable systems.

As shown in FIG. 3, the signaling diagram 300 identifies various interactions involving a tethering device 202, a tethered device 204 or 206, a user 208, an external proxy server 210, and at least one destination 212. In this example, the tethering device 202 is shown as including a framework 302, a first local proxy server 304, and a second local proxy server 306. The framework 302 generally represents logic executed or otherwise supported by the tethering device 202 that controls the use of network proxies and the extension of network proxies to one or more tethered devices 204, 206. For example, the framework 302 can be used to initiate communications involving one or more tethered devices 204, 206 and can initiate execution of the first and second local proxy servers 304, 306.

The first and second local proxy servers 304, 306 represent proxy servers executed by the tethering device 202 itself (which is why they are referred to as “local” proxy servers). The first local proxy server 304 is configured to support the exchange of data traffic with the external proxy server 210. For example, data traffic of the tethering device 202 itself and data traffic of each tethered device 204, 206 can be routed to and from the external proxy server 210 through the first local proxy server 304. The first local proxy server 304 can use a first proxy auto-configuration (PAC) file, where the first PAC file can (among other things) define how the first local proxy server 304 forwards data traffic from the tethering device 202 and any tethered device(s) 204, 206 to the external proxy server 210. In some cases, the tethering device 202 may execute multiple first local proxy servers 304, which can enable the tethering device 202 to communicate with multiple external proxy servers 210.

The second local proxy server 306 is configured to support the exchange of data traffic between the first local proxy server 304 and a tethered device 204, 206. For example, data traffic can be routed between the tethered device 204, 206 and the first local proxy server 304 through the second local proxy server 306. As described below, the second local proxy server 306 can be associated with a second PAC file, which can (among other things) be provided to the tethered device 204, 206 for use in interacting with the tethering device 202. From the perspective of the tethered device 204, 206, the second PAC file can make it appear as if the tethered device 204, 206 is communicating with an actual proxy server. In reality, the tethered device 204, 206 is actually communicating with the tethering device 202. The second PAC file here causes the tethered device 204, 206 to forward its data traffic to the second local proxy server 306, which then forwards that traffic to the first local proxy server 304. In some embodiments, there may be a separate second local proxy server 306 for each tethered device 204, 206, and those second local proxy servers 306 may communicate with the same first local proxy server 304 or with different first local proxy servers 304.

As shown in FIG. 3, the user 208 can use his or her computer or other electronic device to send an enable instruction to the tethering device 202 during an operation 308. The enable instruction represents a command or other instruction for enabling the configuration of one or more network proxies on the tethering device 202. The enable instruction may be provided in any suitable manner, such as during an initial configuration of the tethering device 202 or during a subsequent reconfiguration of the tethering device 202. The enable instruction may be provided as a standalone instruction or as part of a broader set of configuration parameters.

The framework 302 can receive the enable instruction and initiate a download of a first PAC file during an operation 310. For example, the enable instruction or a subsequent communication from the user's device may include a uniform resource locator (URL) or other address of the first PAC file, and the framework 302 can cause the tethering device 202 to download the first PAC file from that network address. The framework 302 initiates execution of the first local proxy server 304 during an operation 312. For example, the framework 302 can cause the tethering device 202 to internally start the first local proxy server 304, which can act as a proxy and to which one, some, or all applications of the tethering device 202 can forward their network traffic. The first local proxy server 304 makes decisions regarding where to forward the traffic based on the first PAC file. In some cases, for instance, the first PAC file may include contents having the following form.

```
function FindProxyForURL(url, host) {
  if (dnsDomainIs(host, “intranet1.com”)) {
    return “DIRECT”;
  }
  if (dnsDomainIs(host, “intranet2.com”)) {
    return “PROXY proxy.intranet1.com:8080”;
  }
  return “NULL”;
}
```

Here, the first local proxy server 304 would use the first PAC file to route traffic directly to a host (identified by a URL) if the host belongs to a first domain (identified as “intranet1.com”). The first local proxy server 304 would also use the first PAC file to route traffic indirectly, using a proxied connection through port 8080 of a proxy, if the host belongs to a second domain (identified as “intranet2.com”). Note that this first PAC file is for illustration only and can easily vary based on the specific circumstances.

The user 208 can also use his or her computer or other electronic device to send a second enable instruction to the tethering device 202 during an operation 314. The second enable instruction represents a command or other instruction for enabling a tethering function of the tethering device 202. In some cases, the tethering device 202 may support the ability to tether in different ways, such as via a WiFi connection, a BLUETOOTH connection, a UNIVERSAL SERIAL BUS (USB) connection, or other or additional connection(s) (or a combination thereof). The second enable instruction may generically enable tethering in any manner or identify one or more permissible types of tethering. Again, the second enable instruction may be provided in any suitable manner and may be provided as a standalone instruction or as part of a broader set of configuration parameters.

The framework 302 can receive the second enable instruction and initiate execution of the second local proxy server 306 during an operation 316. For example, the framework 302 can cause the tethering device 202 to internally start at least one instance of the second local proxy server 306, each of which will act as a proxy between a tethered device 204, 206 and the first local proxy server 304. The second local proxy server 306 can include or be associated with a second PAC file, which will be provided to a tethered device 204, 206 for use in communicating with the second local proxy server 306. For instance, the second PAC file can cause the tethered device 204, 206 to provide its network traffic to the tethering device 202, and any applications executing on the tethered device 204, 206 may view the tethering device 202 as being an actual proxy server. In some cases, for example, the second PAC file may include contents having the following form.

function FindProxyForURL(url, host) {
return “PROXY $ip-address_tethering_device:$local_port_proxy_server_2”
}

This PAC file (when provided to and used by a tethered device 204, 206) would cause the tethered device 204, 206 to route all of its network traffic to the second local proxy server 306 on the tethering device 202. Here, the expression “$ip-address_tethering_device” represents the Internet Protocol (IP) or other address of the tethering device 202, and the expression “$local_port_proxy_server_2” represents the port number used by or associated with the second local proxy server 306 on the tethering device 202. Note that the second PAC file may be obtained in any suitable manner, such as when the second PAC file is downloaded (possibly along with the first PAC file) or is generated by the framework 302 or the second local proxy server 306.

The framework 302 creates a network interface for the tethering device 202 during an operation 318. For example, the framework 302 may create a virtual network interface for the tethering device 202 that will function like an access point, where the access point will be visible to a tethered device 204, 206. When the tethered device 204, 206 actually attempts to link to the tethering device 202, the framework 302 also initiates creation of a network interface on the tethered device 204, 206 during an operation 320. For instance, the framework 302 can initiate creation of a virtual network interface in the tethered device 204, 206. During this process, the framework 302 can also assign a network address, such as an IP or other address, to the tethered device 204, 206 or to the virtual network interface of the tethered device 204, 206. In some cases, for instance, the framework 302 may use or support the Dynamic Host Configuration Protocol (DHCP) in order to assign network addresses to tethered devices. As part of the assignment of a network address or at another time, the framework 302 can pass a URL or other address of the second local proxy server 306 or of the second PAC file associated with the second local proxy server 306. This allows the tethered device 204, 206 to download the second PAC file using its virtual network interface. As noted above, the second PAC file will cause the tethered device 204, 206 to route its data traffic to the second local proxy server 306 of the tethering device 202. From the perspective of the tethered device 204, 206, the tethering device 202 will appear to be an actual proxy server.

At this point, the tethered device 204, 206 can communicate via the tethering device 202, and the network proxy of the tethering device 202 is extended to the traffic for the tethered device 204, 206. For example, the tethered device 204, 206 can send traffic to the second local proxy server 306 during an operation 322, which is supported through the use of the second PAC file by the tethered device 204, 206. The second local proxy server 306 forwards the traffic to the first local proxy server 304 during an operation 324, and the first local proxy server 304 forwards the traffic to the external proxy server 210 during an operation 326. The external proxy server 210 forwards the traffic to one or more hosts at one or more destinations 212 during an operation 328. This may occur for any amount of traffic sent by the tethered device 204, 206 to the tethering device 202, and the traffic may be directed to a single host at a single destination 212 or to multiple hosts at multiple destinations 212. Note that traffic can also flow from the one or more hosts at the one or more destinations 212 to the tethered device 204, 206 through the tethering device 202.

As noted above, in some cases, the tethering device 202 may support the use of a VPN network proxy. For example, in FIG. 3, the first local proxy server 304 may be used as a VPN proxy (or a separate VPN proxy may be provided) so that traffic to and from the tethering device 202 is routed through an external VPN server. The external VPN server can route the traffic to and from the external proxy server 210. In these embodiments, the techniques provided in this disclosure can allow the tethered device 204, 206 to communicate with the external VPN server. This can provide VPN-based protection to the traffic of the tethered device 204, 206 without having to provide an actual VPN network proxy to the tethered device 204, 206.

Again, it should be noted that the functions shown in or described with respect to FIG. 3 can be implemented in electronic devices 101, 102, 104 or other electronic devices in any suitable manner. For example, in some embodiments, at least some of the functions shown in or described with respect to FIG. 3 can be implemented or supported using one or more software applications or other software instructions that are executed by the processors 120 of the electronic devices 101, 102, 104 or other electronic devices. In other embodiments, at least some of the functions shown in or described with respect to FIG. 3 can be implemented or supported using dedicated hardware components. In general, the functions shown in or described with respect to FIG. 3 can be performed using any suitable hardware or any suitable combination of hardware and software/firmware instructions.

Although FIG. 3 illustrates one example of a signaling diagram 300 for extension of a network proxy to traffic for a tethered or other companion device, various changes may be made to FIG. 3. For example, various operations in FIG. 3 may overlap, occur in parallel, occur in a different order, or occur any number of times. Also, there may be any suitable length of time elapsing between various operations shown in FIG. 3, which can vary depending on the circumstances.

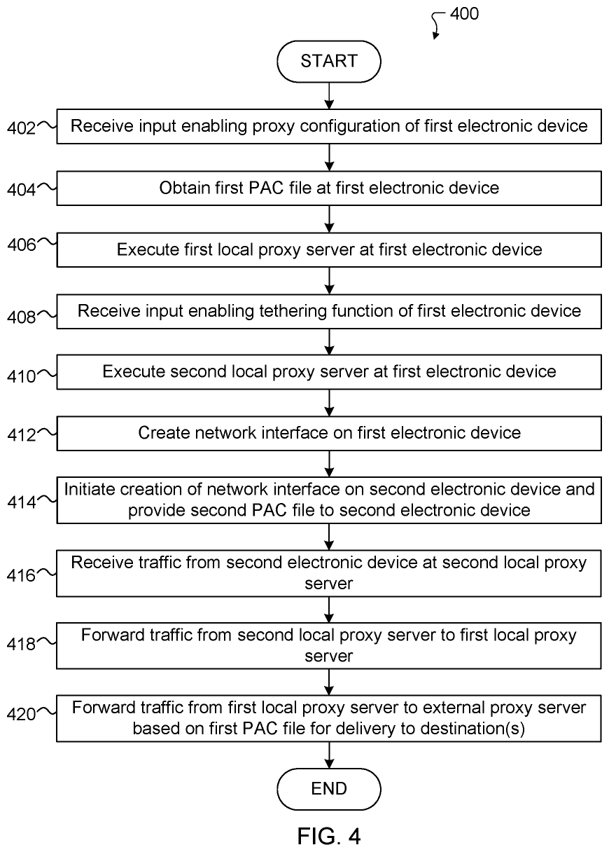

FIG. 4 illustrates an example method 400 for extending a network proxy to traffic for a tethered or other companion device in accordance with this disclosure. For ease of explanation, the method 400 of FIG. 4 is described as involving the various elements 202-212 shown in FIG. 2 and described above, and these elements 202-212 may be associated with the network configuration 100 of FIG. 1. However, the method 400 may be performed using any other suitable elements and in other suitable systems.

As shown in FIG. 4, an input enabling a network proxy configuration of a first electronic device is received at step 402. This may include, for example, the framework 302 of the tethering device 202 receiving an enable instruction initiated by a user 208, where the enable instruction instructs the tethering device 202 to allow for configuration of one or more network proxies. A first PAC file is obtained at the first electronic device at step 404. This may include, for example, the framework 302 of the tethering device 202 downloading the first PAC file from a network location identified by the user 208. Execution of a first local proxy server by the first electronic device is initiated at step 406. This may include, for example, the framework 302 of the tethering device 202 initiating execution of the first local proxy server 304. Among other things, the first local proxy server 304 is configured to receive traffic (such as to or from the tethering device 202 or a tethered device) and forward the traffic based on the first PAC file.

Another input enabling a tethering function of the first electronic device is received at step 408. This may include, for example, the framework 302 of the tethering device 202 receiving another enable instruction initiated by the user 208, where this enable instruction instructs the tethering device 202 to allow tethering. Execution of a second local proxy server by the first electronic device is initiated at step 410. This may include, for example, the framework 302 of the tethering device 202 initiating execution of the second local proxy server 306. Among other things, the second local proxy server 306 is configured to receive traffic from a tethered device and forward the traffic to the first local proxy server 304.

A network interface for the tethering device is created at step 412. This may include, for example, the framework 302 of the tethering device 202 creating a virtual network interface for the tethering device 202, where the virtual network interface will function like an access point that is visible to a tethered device 204, 206. Creation of a network interface for the tethered device is initiated at step 414. This may include, for example, the framework 302 of the tethering device 202 initiating creation of a virtual network interface on the tethered device 204, 206 when the tethered device 204, 206 attempts to link to the tethering device 202. As part of this process, the tethering device 202 can assign a network address to the tethered device 204, 206 or to the virtual network interface of the tethered device 204, 206. Also, the tethering device 202 can provide a second PAC file to the tethered device 204, 206. The second PAC file defines a proxy for the tethered device 204, 206, such as by identifying the IP address or other address of the tethering device 202 and the port number of the tethering device 202 that is associated with the second local proxy server 306.

At this point, the tethered device 204, 206 can communicate via the tethering device 202. For example, traffic from the tethered device may be received by the second local proxy server at step 416. This may include, for example, the second local proxy server 306 of the tethering device 202 receiving the traffic from the tethered device 204, 206 via the specified port of the tethering device 202 as identified in the second PAC file used by the tethered device 204, 206. The traffic is forwarded from the second local proxy server to the first local proxy server at step 418. This may include, for example, the second local proxy server 306 of the tethering device 202 communicating all traffic received over the specified port to the first local proxy server 304 of the tethering device 202. The first local proxy server forwards the traffic to an external proxy server based on the first PAC file at step 420. This may include, for example, the first local proxy server 304 of the tethering device 202 communicating the traffic over a data network for delivery (either directly or indirectly) to an external proxy server 210. If a VPN is supported by the tethering device 202 and a VPN session has been established, this may include the first local proxy server 304 or a separate VPN proxy of the tethering device 202 forwarding the traffic from the first local proxy server 304 to a VPN server, which can forward the traffic to the external proxy server 210.

Although FIG. 4 illustrates one example of a method 400 for extending a network proxy to traffic for a tethered or other companion device, various changes may be made to FIG. 4. For example, while shown as a series of steps, various steps in FIG. 4 may overlap, occur in parallel, occur in a different order, or occur any number of times.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, at a first electronic device, a first proxy auto-configuration (PAC) file;
executing, by the first electronic device, a first local proxy server configured to receive traffic from the first electronic device and at least one second electronic device, the first local proxy server configured to forward the traffic based on the first PAC file;
executing, by the first electronic device, a second local proxy server configured to forward the traffic from the at least one second electronic device to the first local proxy server;
receiving, at the first local proxy server from the second local proxy server, the traffic from the at least one second electronic device; and
forwarding, using the first local proxy server, the traffic from the at least one second electronic device to an external proxy server.

2. The method of claim 1, further comprising:
creating, by the first electronic device, a first network interface on the first electronic device;
initiating, by the first electronic device, creation of a second network interface on each of the at least one second electronic device; and
providing a second PAC file to the at least one second electronic device, the second PAC file identifying a network address and a port associated with the second local proxy server.

3. The method of claim 2, wherein:
the first network interface on the first electronic device is configured to function as an access point visible to the at least one second electronic device; and
each second network interface on each of the at least one second electronic device is configured to download the second PAC file.

4. The method of claim 2, wherein the first electronic device provides the second PAC file to each of the at least one second electronic device during an assignment of a network address to the second network interface of that second electronic device.

5. The method of claim 2, wherein:
the first PAC file is obtained after enabling of a proxy configuration of the first electronic device; and
the second PAC file is provided after enabling of a tethering function of the first electronic device.

6. The method of claim 1, wherein the first local proxy server supports a virtual private network (VPN) proxy and allows the traffic from the at least one second electronic device to be provided to an external VPN server.

7. The method of claim 1, wherein the traffic from the at least one second electronic device is provided to the external proxy server using the first local proxy server for delivery to at least one destination.

8. An electronic device comprising:
at least one communication interface configured to communicate with at least one second electronic device; and
at least one processing device configured to:
obtain a first proxy auto-configuration (PAC) file;
execute a first local proxy server configured to receive traffic from the electronic device and the at least one second electronic device, the first local proxy server configured to forward the traffic based on the first PAC file;
execute a second local proxy server configured to forward the traffic from the at least one second electronic device to the first local proxy server;
receive, at the first local proxy server from the second local proxy server, the traffic from the at least one second electronic device; and
forward, using the first local proxy server, the traffic from the at least one second electronic device to an external proxy server.

9. The electronic device of claim 8, wherein the at least one processing device is further configured to:
create a first network interface on the electronic device;
initiate creation of a second network interface on each of the at least one second electronic device; and
provide a second PAC file to the at least one second electronic device, the second PAC file identifying a network address and a port associated with the second local proxy server.

10. The electronic device of claim 9, wherein:
the first network interface on the electronic device is configured to function as an access point visible to the at least one second electronic device; and
each second network interface on each of the at least one second electronic device is configured to download the second PAC file.

11. The electronic device of claim 9, wherein the at least one processing device is configured to provide the second PAC file to each of the at least one second electronic device during an assignment of a network address to the second network interface of that second electronic device.

12. The electronic device of claim 9, wherein:
the at least one processing device is configured to obtain the first PAC file after enabling of a proxy configuration of the electronic device; and
the at least one processing device is configured to provide the second PAC file after enabling of a tethering function of the electronic device.

13. The electronic device of claim 8, wherein the first local proxy server is configured to support a virtual private network (VPN) proxy and allow the traffic from the at least one second electronic device to be provided to an external VPN server.

14. The electronic device of claim 8, wherein the at least one processing device is configured to forward the traffic from the at least one second electronic device to the external proxy server using the first local proxy server for delivery to at least one destination.

15. A non-transitory machine readable medium containing instructions that when executed cause at least one processor of an electronic device to:
obtain a first proxy auto-configuration (PAC) file;
execute a first local proxy server configured to receive traffic from the electronic device and at least one second electronic device, the first local proxy server configured to forward the traffic based on the first PAC file;
execute a second local proxy server configured to forward the traffic from the at least one second electronic device to the first local proxy server;
receive, at the first local proxy server from the second local proxy server, the traffic from the at least one second electronic device; and
forward, using the first local proxy server, the traffic from the at least one second electronic device to an external proxy server.

16. The non-transitory machine readable medium of claim 15, further containing instructions that when executed cause the at least one processor to:
create a first network interface on the electronic device;
initiate creation of a second network interface on each of the at least one second electronic device; and
provide a second PAC file to the at least one second electronic device, the second PAC file identifying a network address and a port associated with the second local proxy server.

17. The non-transitory machine readable medium of claim 16, wherein:
the first network interface on the electronic device is configured to function as an access point visible to the at least one second electronic device; and
each second network interface on each of the at least one second electronic device is configured to download the second PAC file.

18. The non-transitory machine readable medium of claim 16, wherein the instructions when executed cause the at least one processor to provide the second PAC file to each of the at least one second electronic device during an assignment of a network address to the second network interface of that second electronic device.

19. The non-transitory machine readable medium of claim 16, wherein:
the instructions when executed cause the at least one processor to obtain the first PAC file after enabling of a proxy configuration of the electronic device; and
the instructions when executed cause the at least one processor to provide the second PAC file after enabling of a tethering function of the electronic device.

20. The non-transitory machine readable medium of claim 15, wherein the first local proxy server is configured to support a virtual private network (VPN) proxy and allow the traffic from the at least one second electronic device to be provided to an external VPN server.
